(19) United States
(12) Patent Application Publication
(10) Pub. No.: US 2026/0081943 A1
(43) Pub. Date: Mar. 19, 2026

(54) VULNERABILITY DETECTION FOR CLOUD COMPUTING SYSTEMS

(71) Applicant: Salesforce, Inc., San Francisco, CA (US)

(72) Inventor: Rahul Basapur Sharnappa, San Francisco, CA (US)

(21) Appl. No.: 18/886,445

(22) Filed: Sep. 16, 2024

(51) Int. Cl. H04L 9/40; G06F 8/65; G06F 16/901

(52) U.S. Cl. CPC H04L 63/1433; G06F 8/65; G06F 16/9024

(57) ABSTRACT

Systems, devices, and techniques are disclosed for vulnerability detection for cloud computing systems. A security inventory of a cloud computing server system may be received. A graph database may be generated based on the security inventory of the cloud computing server system. A natural language description of a security vulnerability may be received. A graph query may be generated from the natural language description of a security vulnerability using a generative neural network. The security vulnerability may be detected in the cloud computing server system by running the graph query against the graph database. A report indicating the presence of the security vulnerability in the cloud computing server system may be generated. An action to remediate the security vulnerability in the cloud computing server system may be performed.

### BACKGROUND

Cloud computing systems can be subject to numerous security vulnerabilities. These vulnerabilities can include misconfigured identity and access management (IAM) users and roles that allow unwanted privilege escalation and database services that allow unsecured configurations. Efficiently analyzing and detecting vulnerabilities within cloud computing systems may be difficult due to the size, complexity and dynamic nature of the cloud computing systems.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for vulnerability detection for cloud computing systems according to an implementation of the disclosed subject matter.

FIG. 2 shows an example arrangement suitable for vulnerability detection for cloud computing systems according to an implementation of the disclosed subject matter.

FIG. 3 shows an example arrangement suitable for vulnerability detection for cloud computing systems according to an implementation of the disclosed subject matter.

FIG. 4A shows an example arrangement suitable for vulnerability detection for cloud computing systems according to an implementation of the disclosed subject matter.

FIG. 4B shows an example arrangement suitable for vulnerability detection for cloud computing systems according to an implementation of the disclosed subject matter.

FIG. 5 shows an example procedure suitable for vulnerability detection for cloud computing systems according to an implementation of the disclosed subject matter.

FIG. 6 shows an example procedure suitable for vulnerability detection for cloud computing systems according to an implementation of the disclosed subject matter.

FIG. 7 shows an example procedure suitable for vulnerability detection for cloud computing systems according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable vulnerability detection for cloud computing systems, which may allow for the automatic detection and mitigation of security vulnerabilities in a cloud computing server system. An inventory of a cloud computing server system may be received. A graph database may be generated based on the inventory of the cloud computing server system. A natural language description of a security vulnerability may be received. A graph query may be generated from the natural language description of a security vulnerability using a generative neural network. The security vulnerability may be detected in the cloud computing server system by running the graph query against the graph database. A report indicating the presence of the security vulnerability in the cloud computing server system may be generated. An action to remediate the security vulnerability in the cloud computing server system may be performed.

An inventory of a cloud computing server system may be received. The security inventory of the cloud computing server system may be read from the cloud computing server system. The cloud computing server system may, for example, provide application programming interfaces (APIs) that may be used to send API requests for the security inventory of the cloud computing server system. The security inventory may be received as response to the API requests. As the security inventory of the cloud computing server system is updated, the updates may be received through access to auditing and logging services of the cloud computing server system. The security inventory may include, for example, data concerning resources of the cloud computing server system including the virtual servers and instances provided by the cloud computing server system, storage buckets provided by the cloud computing server system, IAM roles on the cloud computing server system, security policies of the cloud computing server system, virtual private cloud (VPC) configurations used by the cloud computing server system, and network interfaces of the cloud computing server system.

A graph database may be generated based on the inventory of the cloud computing server system. The security inventory received from the cloud computing server system may be used to generate a graph database for the cloud computing server system. The graph database may represent the security inventory in the form of a graph, including nodes connected by edges. The nodes may represent the resources included in the security inventory, such as, for example, user accounts, virtual servers, and storage buckets, and the edges may represent relationships and interactions, such as network connectivity or policy associations, between the resources in the security inventory represented by nodes connected by the edges. The graph database may be updated as the security inventory of the cloud computing server system is updated.

A natural language description of a security vulnerability may be received. The natural language descriptions of the security vulnerability may be received from any suitable source that may include natural language of descriptions of security vulnerabilities, such as, for example, a website to which Common Vulnerabilities and Exposures (CVE) descriptions are posted for security vulnerabilities as they are identified. The natural language descriptions of the security vulnerabilities may have been generated in any suitable manner and may provide a suitable description of the security vulnerability such that it may be used to identify the presence of the security vulnerability in a cloud computing server system. For example, the natural language descriptions of the security vulnerability may include an identification of any hardware or software exposed to the vulnerability, a description of how the vulnerability may be exploited, why the vulnerability exists, and the security issues that may result from exploitation of the vulnerability.

A graph query may be generated from the natural language description of a security vulnerability using a generative neural network. The generative neural network may be any suitable generative neural network trained in any suitable manner, including, for example, a generative neural network trained on security best practices for cloud computing server systems, cloud architecture patterns, and known vulnerabilities of cloud computing server systems. The natural language description of the security vulnerability may be input to the generative neural network with an instruction to the generative neural network to generate a graph query that can be run on the graph database to determine if the security vulnerability is present in the cloud computing server system. The input to the generative neural network may be enhanced using retrieval augmented generation (RAG), which may retrieve additional data related to be used as input. Other data input to the generative neural network along with the natural language description of the security vulnerability may include, for example, a schema of the graph database and additional data related to the security vulnerability retrieved from any suitable sources. The graph query generated by the generative neural network may use any suitable form and syntax that may be usable with the graph database. An example of the graph query generated by the generative neural network to identify user accounts exposed to a security vulnerability involving access keys may be:

```
  MATCH (u:user)-[:access_key]−>(ak:acess_key)
  WHERE ak.status = ‘Active’ AND apoc.date.parse(ak.last_used_date,
‘ms’, ‘yyyy-MM-dd\ ‘T\’ HH:mm:ss
  RETURN u.name AS UserName, ak.access_key_id as AccessKeyID,
  ak.last_used_{—}
```

The generative neural network may generate the graph query to include the appropriate terminology for the cloud computing server system, as different cloud computing server systems may use different terminology for resources than that which is used in the natural language description of a security vulnerability.

The security vulnerability may be detected in the cloud computing server system by running the graph query against the graph database. The graph query generated by the generative neural network based on the natural language description of the security vulnerability may be run against the graph database. The result of running the graph query against the graph database may be the identification of resources from the security inventory of the cloud computing server system, as represented in the graph database, that are exposed to the security vulnerability. For example, if the security vulnerability concerns user accounts, running the graph query against the graph database may return the identification of any user accounts on the cloud computing server system exposed to the security vulnerability. If a graph query run against the graph database returns no results, the cloud computing server system may have no resource exposed to the security vulnerability from whose natural language description the graph query was generated.

A report indicating the presence of the security vulnerability in the cloud computing server system may be generated. Security vulnerabilities detected in the cloud computing server system by running graph queries against the graph database may be added to reports. The reports may be human-readable and may include an identification of security vulnerabilities and the resources from the security inventory exposed to the security vulnerabilities, descriptions of the potential impact of the cloud computing server system having resources exposed to the security vulnerabilities, and suggested actions for mitigation or remediation of the security vulnerabilities. The reports may be sent to any suitable user of the cloud computing server system using any suitable form of electronic communication.

An action to remediate the security vulnerability in the cloud computing server system may be performed. Security vulnerabilities detected in the cloud computing server system may be remediated in any suitable manner, which may be dependent on the nature of the security vulnerability and the resources exposed to the security vulnerability. For example, user accounts determined to be exposed to a security vulnerability may be automatically disabled or may have their security permissions automatically adjusted, for example, reduced. Network interfaces determined to be exposed to a security vulnerability may, for example, have settings automatically changed. Policies of the cloud computing server system may be automatically changed to remediate detected security vulnerabilities. The detected security vulnerabilities may also be remediated through the automatic generation, using the generative neural network and deployment of code to any suitable components of the cloud computing server system.

Graph queries may be continually generated by the generative neural network as new natural language descriptions of security vulnerabilities are received. Graph queries may be run against the graph database as the graph queries are generated, allowing for new security vulnerabilities to be detected in security inventory of the cloud computing server system.

The graph queries generated by the generative neural network may be stored. The stored graph queries may be re-run against the graph database at any suitable time, for example, as the graph database is updated based on updates to the security inventory, allowing for the detection of security vulnerabilities resulting from updates to the security inventory of the cloud computing server system. This may allow for real-time monitoring of the cloud computing server system for security vulnerabilities as the security inventory of the cloud computing server system is updated and new natural language descriptions of security vulnerabilities are received.

The use of a graph database and graph queries may allow for more efficient detection of security vulnerabilities even as cloud computing server systems increase in size and complexity. The graph queries may not need to use computationally expensive “join” operations that may be used by relational database management systems (RDBMS) that may also be used to detect security vulnerabilities in a cloud computing server system. The use of the graph database and graph queries may also allow for the detection of security vulnerabilities that involve multiple interdependent resources and configuration, such as, for example, chained privilege escalation scenarios and multi-step data exfiltration paths, which may be otherwise difficult to detect.

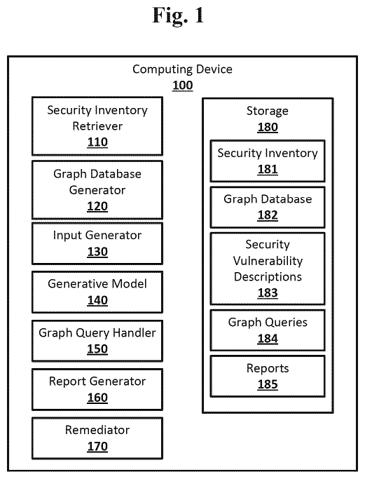

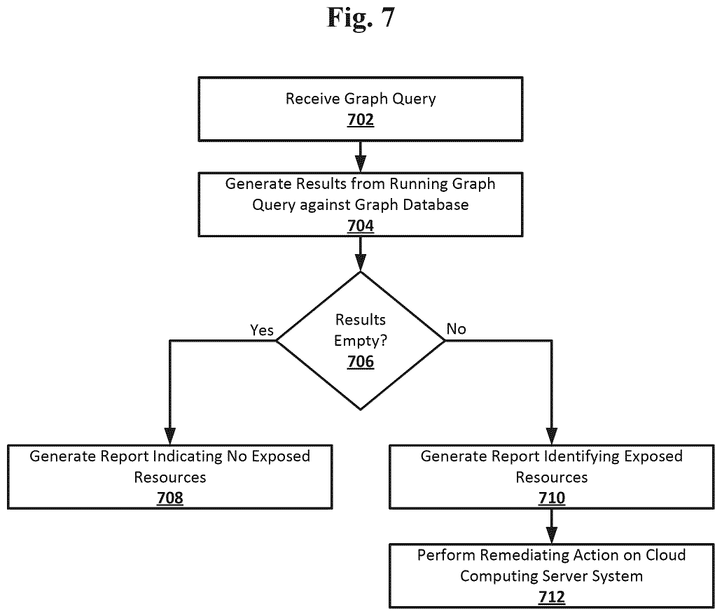

FIG. 1 shows an example system suitable for vulnerability detection for cloud computing systems according to an implementation of the disclosed subject matter. A computing device 100 may be, for example, the computer 20 as described in FIG. 8, or components thereof. The computing device 100 may include any number computing devices, each of which may include any suitable combination of central processing units (CPUs), graphical processing units (GPUs), and tensor processing units (TPUs). The computing device 100 may be distributed over any geographic area, and may, for example, include geographically disparate computing devices connected through any suitable network connections. The computing device 100 may be, or be a part of, a cloud computing server system that may support multi-tenancy.

The computing device 100 may include a security inventory retriever 110. The security inventory retriever 110 may be any suitable combination of hardware and software on the computing device 100 that may retrieve the security inventory from a cloud computing server system. The security inventory retriever 110 may, for example, use application programming interfaces (APIs) provided by the cloud computing server system to send API requests for the security inventory of the cloud computing server system. The security inventory retriever 110 may receive the security inventory as response to the API requests. The security inventory retriever 110 may retrieve updates made to the security inventory of the cloud computing server system through access to auditing and logging services of the cloud computing server system. The security inventory retriever 110 may store the received security inventory as security inventory 181 in storage 180 of the computing device 100. The security inventory 181 may include, for example, data on the virtual servers and instances provided by the cloud computing server system, storage buckets provided by the cloud computing server system, IAM roles on the cloud computing server system, security policies of the cloud computing server system, virtual private cloud (VPC) configurations used by the cloud computing server system, and network interfaces of the cloud computing server system.

The computing device 100 may include a graph database generator 120. The graph database generator 120 may be any suitable combination of hardware and software on the computing device 100 that may generate a graph database from a security inventory. For example, the graph database generator 120 may generate a graph database 182 from the security inventory 181. The graph database generator 120 may generate the graph database 182 to represent the security inventory 181 in the form of a graph, including nodes connected by edges. The nodes may represent the resources included in the security inventory 181, such as, for example, user accounts, virtual servers, and storage buckets, and the edges may represent relationships and interactions, such as network connectivity or policy associations, between the resources in the security inventory represented by nodes connected by the edges. The graph database generator 120 may update the graph database 182 as the security inventory 181 of the cloud computing server system is updated by the security inventory retriever 110.

The computing device 100 may include an input generator 130. The input generator 130 may be any suitable combination of hardware and software on the computing device 100 for generating input prompts for a generative model such as a generative neural network. The input generator 130 may receive natural language descriptions of security vulnerabilities from any suitable source that may include natural language of descriptions of security vulnerabilities, such as, for example, a website or database to which Common Vulnerabilities and Exposures (CVE) descriptions are posted for security vulnerabilities as they are identified. The input generator 130 may generate prompts to be input to a generative model using the received natural language of descriptions of security vulnerabilities and instructions to the generative model to generate a graph query that can be run on the graph database 182 to determine if the security vulnerabilities are present in the cloud computing server system. The input generator 130 may enhance the prompt generated based on the natural language description of security vulnerability using retrieval augmented generation (RAG) by retrieving additional data related to the security vulnerability and the graph database 182 to add to the prompt, such as, for example, a schema of the graph database 182 and additional data related to the security vulnerability retrieved from any suitable sources. The input generator 130 may generate a separate prompt for each natural language description of a security vulnerability. The input generator 130 may generate new prompts as new natural language descriptions of security vulnerabilities are received. The input generator 130 may store received natural language descriptions of security vulnerabilities as the security vulnerability descriptions 183 in the storage 180.

The computing device 100 may include a generative model 140. The generative model 140 may be any suitable combination of hardware and software on the computing device 100 for implementing a generative model such as a generative neural network. The generative model 140 may have any suitable structure and may have been trained in in any suitable manner using any suitable data. The generative model 140 may, for example, be trained on security best practices for cloud computing server systems, cloud architecture patterns, and known vulnerabilities of cloud computing server systems. The generative model 140 may receive prompts generated by the input generator 130 based on natural language descriptions of security vulnerabilities and may generate graph queries that may use any suitable form and syntax that may be run against the graph database 182 to determine if the graph database 182 indicate the presence of the security vulnerabilities in the cloud computing server system. The generative model 140 may generate a single graph query for each prompt input from the input generator 130. Graph queries generated by the generative model 140 may be stored as graph queries 184, which may allow the graph queries to be re-used after they are generated.

The computing device 100 may include a graph query handler 150. The graph query handler 150 may be any suitable combination of hardware and software on the computing device 100 that may run a graph query against a graph database. The graph query handler 150 may receive graph queries generated by the generative model 140 either directly or from the graph queries 184 and run them against the graph database 182 to determine if the security vulnerability used to generate the graph query is detected in the cloud computing server system. The result of the graph query handler 150 running a graph query against the graph database 182 may be the identification of resources from the security inventory 181 of the cloud computing server system, as represented in the graph database 182, that are exposed to the security vulnerability used to generate the graph query by the generative model 140. For example, if the security vulnerability concerns user accounts, the graph query handler 150 may run the graph query against the graph database 182 resulting in the identification of any user accounts on the cloud computing server system exposed to the security vulnerability. If a graph query run against the graph database 182 by the graph query handler 150 returns no results, the cloud computing server system may have no resource exposed to the security vulnerability from whose natural language description the graph query was generated.

The computing device 100 may include report generator 160. The report generator 160 may be any suitable combination of hardware and software on the computing device 100 for generating reports on security vulnerabilities detected in the cloud computing server system. The report generator 160 may generate reports, such as reports 185, based on the detection of security vulnerabilities in the cloud computing server system by the graph query handler 150 running graph queries against the graph database 182. The report generator 160 may generate reports that are human-readable and may include an identification of security vulnerabilities and the resources from the security inventory 181 exposed to the security vulnerabilities, descriptions of the potential impact of the cloud computing server system having resources exposed to the security vulnerabilities, and suggested actions for mitigation or remediation of the security vulnerabilities. The report generator 160 may send the reports to any suitable user of the cloud computing server system using any suitable form of electronic communication and may store the reports as the reports 185.

The computing device 100 may include a remediator 170. The remediator 170 may be any suitable combination of hardware and software on the computing device 100 for automatically remediating security vulnerabilities detected in the cloud computing server system. The remediator 170 may remediate security vulnerabilities detected in the cloud computing server system, as detected by the graph query handler 150, in any suitable manner, which may be dependent on the nature of the security vulnerability and the resources exposed to the security vulnerability. For example, the remediator 170 may automatically disable user accounts of the cloud computing server system determined to be exposed to a security vulnerability or may automatically adjust their security permissions automatically adjusted, for example, reducing them. The remediator may automatically adjust settings for network interfaces of the cloud computing server system that were determined to be exposed to a security vulnerability. The remediator 170 may automatically change policies of the cloud computing server system to remediate detected security vulnerabilities. The remediator 170 may automatically generate, using the generative neural network, and deploy code to any suitable components of the cloud computing server system to remediate detected security vulnerabilities.

The storage 180 may be any suitable combination of hardware and software for storing data on any suitable physical storage mediums that may be part of or accessible to the computing device 100, including local storage and storage accessible over wired or wireless connections including network connections. The storage 170 may store the security inventory 181, the graph database 182, the security vulnerability descriptions 183, the graph queries 184, and the reports 185.

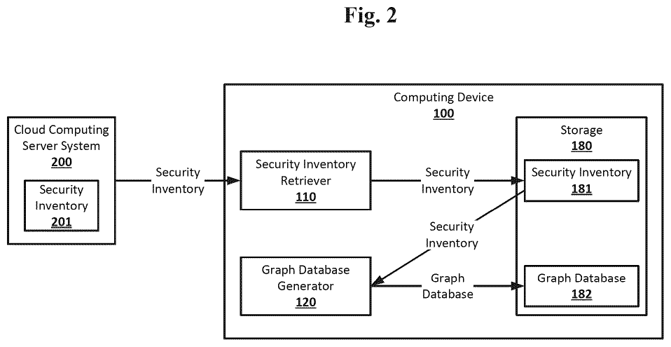

FIG. 2 shows an example arrangement suitable for vulnerability detection for cloud computing systems according to an implementation of the disclosed subject matter. The security inventory retriever 110 may receive a security inventory 201 of a cloud computing server system 200. The cloud computing server system 200 may be a server system that may include computing devices such as, for example, the computer 20 as described in FIG. 8, or components thereof. The cloud computing server system 200 may include any number computing devices, each of which may include any suitable combination of central processing units (CPUs), graphical processing units (GPUs), and tensor processing units (TPUs). The cloud computing server system 200 may be distributed over any geographic area, and may, for example, include geographically disparate computing devices connected through any suitable network connections. In some implementations, the computing device 100 may be a component of the cloud computing server system 200.

The security inventory retriever 110 may receive the security inventory 201 of the cloud computing server system 200 in any suitable manner, including, for example, through use of APIs made available by the cloud computing server system 200 and access to auditing and logging services of the cloud computing server system 200. The received security inventory 201 may be stored as the security inventory 181 in the storage 180 of the computing device 100. The security inventory retriever 110 may receive the security inventory 201 and updates to the security inventory 201 at any suitable intervals so that the security inventory 181 may reflect the current states of the security inventory 201 as changes are made to the security inventory 201.

The graph database generator 120 may receive the security inventory 181 and generate the graph database 182. The graph database 182 may represent the security inventory 181, and thus the current security inventory 201 if the security inventory 181 is up-to-date, in the form of a graph, including nodes connected by edges. The nodes may represent the resources included in the security inventory 181, such as, for example, user accounts, virtual servers, and storage buckets, and the edges may represent relationships and interactions, such as network connectivity or policy associations, between the resources in the security inventory represented by nodes connected by the edges. The graph database generator 120 may update the graph database 182 as the security inventory 181 of the cloud computing server system is updated by the security inventory retriever 110 based on updates to the security inventory 201.

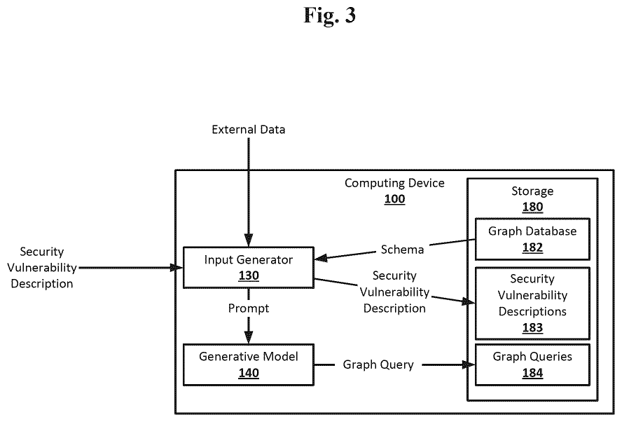

FIG. 3 shows an example arrangement suitable for vulnerability detection for cloud computing systems according to an implementation of the disclosed subject matter. The input generator 130 may receive a security vulnerability description, external data, and a schema of the graph database 182, and may generate a prompt to be used as input to the generative model 140. The input generator 130 may receive the security vulnerability description, which may be a natural language description of a security vulnerability, from any suitable source, such as, for example, a website or database of CVEs. The input generator 130 may receive external data, which may be additional data related to the security vulnerability, using RAG. For example, the input generator 130 may retrieving the external data by searching for the security vulnerability, or any aspects of its description, on any suitable and accessible source of data. The external data may be used with the natural language description of the security vulnerability and the schema of the graph database 182 to generate a prompt that may be used to cause the generative model 140 to generate a graph query that may be run against the graph database 182 to detect the security vulnerability. The prompt may, for example, include an instruction for the generative model 140 to generate a graph query that may be run against the graph database 182, based on the input schema, and will return any resources represented in the graph database 182 that can be exploited according to the security vulnerability as described in the natural language description and any data retrieved using RAG. The input generator 130 may generate new prompts as new natural language descriptions of security vulnerabilities are received. The input generator 130 may store received natural language descriptions of security vulnerabilities as the security vulnerability descriptions 183 in the storage 180.

The generative model 140 may receive the prompt from the input generator 130. The generative model 140 may generate a graph query based on the prompt. The graph query generated by the generative model 140 may use any suitable form and syntax that may be usable with the graph database 182. The graph query may be generated so that the result of running the graph query against the graph database 182 may be the identification of any resources from the security inventory 181, and thus the security inventory 201, that may be vulnerable to exploitation according to the security vulnerability used to generate the prompt, if there are any such resources. The graph query generated by the generative model 140 may be stored with the graph queries 184 so that it may be re-used at any suitable times.

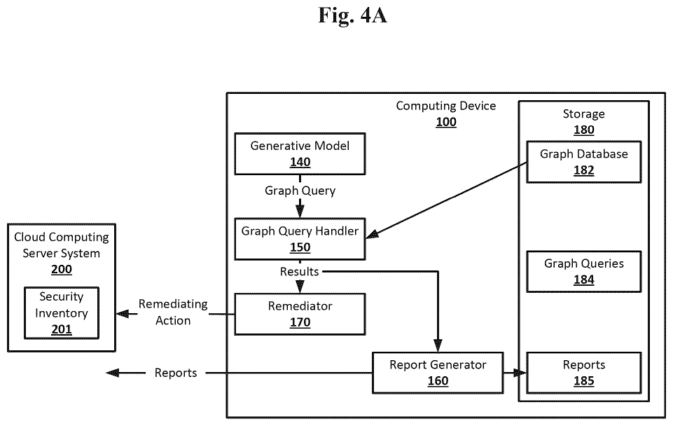

FIG. 4A shows an example arrangement suitable for vulnerability detection for cloud computing systems according to an implementation of the disclosed subject matter. A graph query generated by the generative model 140 in response to a prompt from the prompt generator 130 may be input to the graph query handler 150. The graph query handler 150 may run the graph query against the graph database 182 to generate results which may be, for example, an identification of any resources of the security inventory 181, represented in the graph database 182, that are exposed to the security vulnerability whose natural language description was used to generate the prompt that was used to generate the graph query. The results may be output from the graph query handler 150 to the report generator 160. If the results are not empty, which would indicate that no resources in the security inventory 181 are exposed to the security vulnerability, the results may also be sent to the remediator 170. The report generator 160 may generate a report from the results received from the graph query handler 150. The report may be generated by the report generator 160 may be sent to any suitable party using any suitable form of electronic communication and may also be stored with the reports 185. The remediator 170 may automatically perform a remediating action on the cloud computing server system 200 to remediate the security vulnerability, for example, making changes to any suitable resource of the security inventory 201 based on the resources of the security inventory 181 identified in the report as being exposed to the security vulnerability.

FIG. 4B shows an example arrangement suitable for vulnerability detection for cloud computing systems according to an implementation of the disclosed subject matter. A graph query generated by the generative model 140 in response to a prompt from the prompt generator 130 and previously stored with the graph queries 184 may be input to the graph query handler 150. The graph query handler 150 may run the graph query against the graph database 182 to generate results which may be, for example, an identification of any resources of the security inventory 181, represented in the graph database 182, that are exposed to the security vulnerability whose natural language description was used to generate the prompt that was used to generate the graph query. The results may be output from the graph query handler 150 to the report generator 160. If the results are not empty, which would indicate that no resources in the security inventory 181 are exposed to the security vulnerability, the results may also be sent to the remediator 170. The report generator 160 may generate a report from the results received from the graph query handler 150. The report may be generated by the report generator 160 may be sent to any suitable party using any suitable form of electronic communication and may also be stored with the reports 185. The remediator 170 may automatically perform a remediating action on the cloud computing server system 200 to remediate the security vulnerability, for example, making changes to any suitable resource of the security inventory 201 based on the resources of the security inventory 181 identified in the report as being exposed to the security vulnerability.

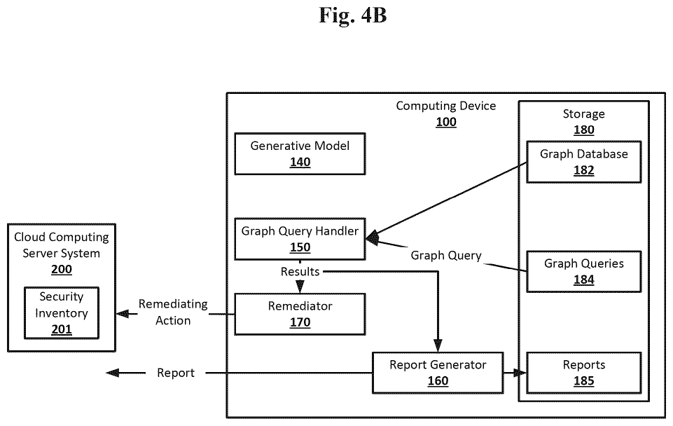

FIG. 5 shows an example procedure suitable for vulnerability detection for cloud computing systems according to an implementation of the disclosed subject matter. At 502, a security inventory may be received. For example, the security inventory retriever 110 may receive the security inventory 201 from the cloud computing server system 200. The security inventory retriever 110 may store the security inventory 201 as the security inventory 181. The security inventory retriever 110 may also receive updates to the security inventory 201 and may update the security inventory 181 accordingly.

At 504, a graph database my be generated. For example, the graph database generator 120 may generate the graph database 182 from the security inventory 181. The graph database generator 120 may generate the graph database 182 when the security inventory 181 is stored by the security inventory retriever 110 and may update the graph database 182 when the security inventory 181 is updated.

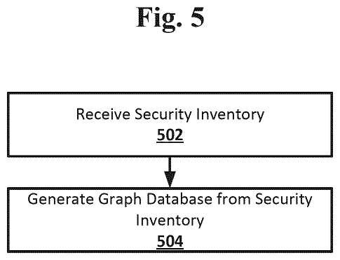

FIG. 6 shows an example procedure suitable for vulnerability detection for cloud computing systems according to an implementation of the disclosed subject matter. At 602, a natural language description of a security vulnerability may be received. For example, the input generator 130 may receive a natural language description of a security vulnerability, such as a CVE, from any suitable source, such as, for example, websites and databases for CVEs. The natural language description of a security vulnerability may describe a security vulnerability that may be found in cloud computing server systems.

At 604, a prompt may be generated from the natural language description of a security vulnerability. For example, the input generator 130 may generate a prompt that may include the natural language description of a security vulnerability and may instruct a generative neural network to generate a graph query that may be run against the graph database 182 to determine if the resources of the security inventory 181 are exposed to the security vulnerability. The input generator 130 may use RAG to enhance the generated prompt, for example, adding additional data about the security vulnerability to the prompt, adding the schema of the graph database 182 to the prompt, and adding any other suitable data from any suitable external source to the prompt.

At 606, a graph query may be generated from the prompt. For example, the prompt generated by the input generator 130 may be used as input to the generative model 140. The generative model 140 may generate a graph query in accordance with prompt. The graph query generated by the generative model 140 may be run against the graph database 182 to determine if resources of the security inventory 181, as represented by the graph database 182, and thus the cloud computing server system 200, are exposed to the security vulnerability whose natural language description was used to generate the prompt. The graph query may be stored with the graph queries 184 so that it may be run against the graph database 182 at any suitable time.

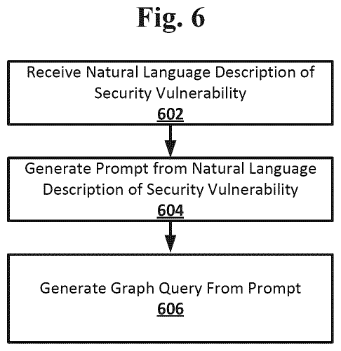

FIG. 7 shows an example procedure suitable for vulnerability detection for cloud computing systems according to an implementation of the disclosed subject matter. At 702, a graph query may be received. For example, the graph query handler 150 may receive a graph query directly from the generative model 140 or from the graph queries 184, which may include previously generated graph queries.

At 704, results may be generated from running the graph query against a graph database. For example, the graph query handler 150 may run the received graph query against the graph database 182 to generate results. The generated results may include an identification of any resource of the security inventory 181 that were responsive to the graph query based on the representation of those resource within the graph database 182, indicating that these resources are exposed to the security vulnerability whose natural language description was used to generate the prompt used to generate the graph query.

At 706, if the results are empty, flow may proceed to 708. Otherwise, flow may proceed to 710. The results generated by the graph query handler 150 from running the graph query against the graph database 182 may be empty if no resources from the security inventory 181 were responsive to the graph query based on their representation in the graph database 182. This may indicate that no resource in the security inventory 181 are exposed to the security vulnerability whose natural language description was used to generate the prompt used to generate the graph query that had empty results.

At 708, a report indicating no exposed resource may be generated. For example, the empty results from the graph query handler 150 may be sent to the report generator 160. The report generator 160 may generate a report indicating that no resources from the security inventory 181 were found to be exposed to the security vulnerability whose natural language description was used to generate the prompt used to generate the graph query that had empty results. The report may also indicate that the cloud computing server system 200 is not exposed to the security vulnerability.

At 710, a report identifying the exposed resources may be generated. For example, the report generator 160 may receive the results identifying resources of the security inventory 181 exposed to the security vulnerability whose natural language description was used to generate the prompt used to generate the graph query that was run against the graph database 182 by the graph query handler 150 to generate the results. The report may include any other suitable information, including, for example, the natural language description of the security vulnerability, any available additional information about the security vulnerability and the exposed resources, and a description of any remediating actions taken by the remediator 170 to remediate the security vulnerability on the cloud computing server system 200. The report may be stored with the reports 185 and may also be sent using any suitable form of electronic communication to any suitable party.

At 712, a remediating action may be performed on the cloud computing server system. For example, the remediator 170 may receive the results from the graph query handler 150 identifying the resources of the security inventory 181 exposed to the security vulnerability. The identified resource may correspond to resources in the security inventory 201 of the cloud computing system 200. The remediator may perform any suitable remediating actions on the cloud computing system 200 to remediate the security vulnerability, for example, modifying or removing resources from, or adding resources to, the security inventory 201 of the cloud computing system 200 based on the identified resources from the security inventory 181. The remediating action performed by the remediator 170 may be, for example, removing privileges from a user account of the cloud computing server system 200, changing a security policy of the cloud computing server system 200, or generating and deploying code to the cloud computing server system 200.

Implementations of the presently disclosed subject matter may be implemented in and used with a variety of component and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

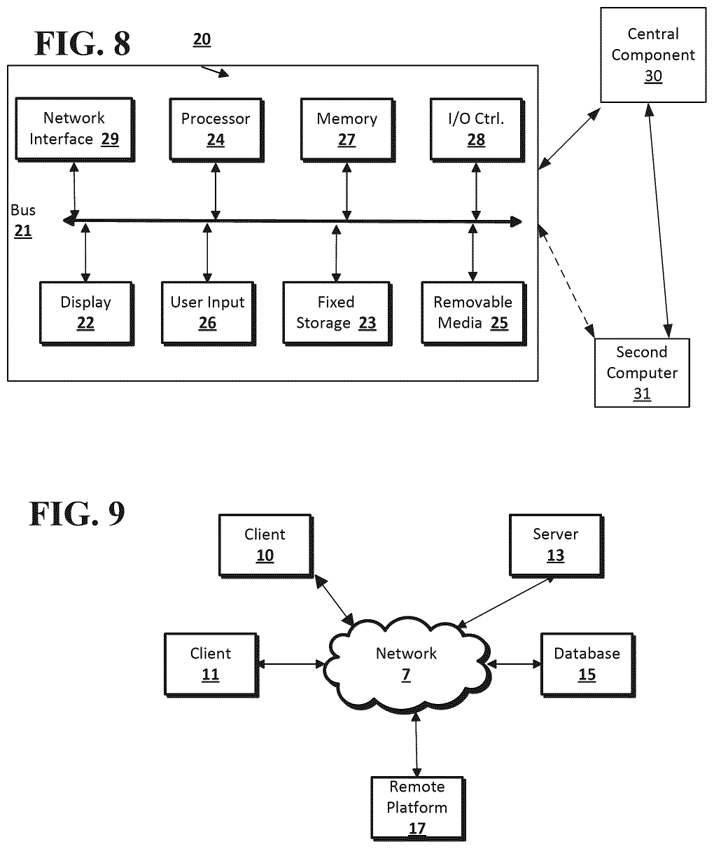

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving a security inventory of a cloud computing server system;
generating a graph database based on the security inventory of the cloud computing server system;
receiving a natural language description of a security vulnerability;
generating from the natural language description of a security vulnerability, using a generative neural network, a graph query;
detecting the security vulnerability in the cloud computing server system by running the graph query against the graph database;
generating a report indicating the presence of the security vulnerability in the cloud computing server system; and
performing at least one action to remediate the security vulnerability in the cloud computing server system.

2. The method of claim 1, wherein generating from the natural language description of the security vulnerability, using the generative neural network, the graph query further comprises:
receiving at least one item of additional data related to the security vulnerability from at least one external source;
generating a prompt for input to the generative neural network based on the natural language description of the security vulnerability, a schema of the graph database, and the at least one item of additional data; and
inputting the prompt to the generative neural network.

3. The computer-implemented method of claim 1, wherein the security inventory comprises data on resources of the cloud computing server system, the resource comprising one or more of the virtual servers and instances provided by the cloud computing server system, storage buckets provided by the cloud computing server system, identity and access management (IAM) roles on the cloud computing server system, security policies of the cloud computing server system, virtual private cloud (VPC) configurations used by the cloud computing server system, and network interfaces of the cloud computing server system.

4. The computer-implemented method of claim 1, wherein detecting the security vulnerability in the cloud computing server system by running the graph query against the graph database comprises determining the identity of resources of the security inventory that are responsive to the graph query based on a representation of the resources in the graph database.

5. The computer-implemented method of claim 1, wherein performing at least one action to remediate the security vulnerability in the cloud computing server system comprises one or more of modifying, removing, adding resources in the security inventory of the cloud computing server system.

6. The computer-implemented method of claim 1, wherein performing at least one action to remediate the security vulnerability in the cloud computing server system comprises generating, with the generative neural network, code to remediate the security vulnerability and deploying the code to the cloud computing server system.

7. The computer-implemented method of claim 1, wherein the nodes the graph database comprises data for nodes representing resources of security inventory and edges representing relationships and interactions between the resources in the security inventory.

8. A computer-implemented system comprising:
a storage; and
a processor that receives a security inventory of a cloud computing server system,
generating a graph database based on the security inventory of the cloud computing server system,
receives a natural language description of a security vulnerability,
generates from the natural language description of a security vulnerability, using a generative neural network, a graph query,
detects the security vulnerability in the cloud computing server system by running the graph query against the graph database,
generates a report indicating the presence of the security vulnerability in the cloud computing server system, and
performs at least one action to remediate the security vulnerability in the cloud computing server system.

9. The computer-implemented system of claim 8 wherein the processor generates from the natural language description of the security vulnerability, using the generative neural network, the graph query by
receiving at least one item of additional data related to the security vulnerability from at least one external source,
generating a prompt for input to the generative neural network based on the natural language description of the security vulnerability, a schema of the graph database, and the at least one item of additional data, and
inputting the prompt to the generative neural network.

10. The computer-implemented system of claim 8, wherein the security inventory comprises data on resources of the cloud computing server system, the resource comprising one or more of the virtual servers and instances provided by the cloud computing server system, storage buckets provided by the cloud computing server system, identity and access management (IAM) roles on the cloud computing server system, security policies of the cloud computing server system, virtual private cloud (VPC) configurations used by the cloud computing server system, and network interfaces of the cloud computing server system.

11. The computer-implemented system of claim 8, wherein the processor detects the security vulnerability in the cloud computing server system by running the graph query against the graph database by further determining the identity of resources of the security inventory that are responsive to the graph query based on a representation of the resources in the graph database.

12. The computer-implemented system of claim 8, wherein the processor performs at least one action to remediate the security vulnerability in the cloud computing server system by one or more of modifying, removing, adding resources in the security inventory of the cloud computing server system.

13. The computer-implemented system of claim 8, wherein the processor performs at least one action to remediate the security vulnerability in the cloud computing server system by generating, with the generative neural network, code to remediate the security vulnerability and deploying the code to the cloud computing server system.

14. The computer-implemented system of claim 8, wherein the nodes the graph database comprises data for nodes representing resources of security inventory and edges representing relationships and interactions between the resources in the security inventory.

15. A system comprising: one or more computers and one or more non-transitory storage devices storing instructions which are operable, when executed by the one or more computers, to cause the one or more computers to perform operations comprising:
receiving a security inventory of a cloud computing server system;
generating a graph database based on the security inventory of the cloud computing server system;
receiving a natural language description of a security vulnerability;
generating from the natural language description of a security vulnerability, using a generative neural network, a graph query;
detecting the security vulnerability in the cloud computing server system by running the graph query against the graph database;
generating a report indicating the presence of the security vulnerability in the cloud computing server system; and
performing at least one action to remediate the security vulnerability in the cloud computing server system.

16. The system of claim 15, wherein the instructions which are operable, when executed by the one or more computers, to cause the one or more computers to perform operations comprising generating from the natural language description of the security vulnerability, using the generative neural network, the graph query further cause the one or more computers to perform operations comprising:
receiving at least one item of additional data related to the security vulnerability from at least one external source;
generating a prompt for input to the generative neural network based on the natural language description of the security vulnerability, a schema of the graph database, and the at least one item of additional data; and
inputting the prompt to the generative neural network.

17. The system of claim 15, wherein the security inventory comprises data on resources of the cloud computing server system, the resource comprising one or more of the virtual servers and instances provided by the cloud computing server system, storage buckets provided by the cloud computing server system, identity and access management (IAM) roles on the cloud computing server system, security policies of the cloud computing server system, virtual private cloud (VPC) configurations used by the cloud computing server system, and network interfaces of the cloud computing server system.

18. The system of claim 15, wherein the instructions which are operable, when executed by the one or more computers, to cause the one or more computers to perform operations comprising detecting the security vulnerability in the cloud computing server system by running the graph query against the graph database further cause the one or more computers to perform operations comprising determining the identity of resources of the security inventory that are responsive to the graph query based on a representation of the resources in the graph database.

19. The system of claim 15, wherein the instructions which are operable, when executed by the one or more computers, to cause the one or more computers to perform operations comprising performing at least one action to remediate the security vulnerability in the cloud computing server system further cause the one or more computers to perform operations comprising one or more of modifying, removing, adding resources in the security inventory of the cloud computing server system.

20. The system of claim 15, wherein the instructions which are operable, when executed by the one or more computers, to cause the one or more computers to perform operations comprising performing at least one action to remediate the security vulnerability in the cloud computing server system further cause the one or more computers to perform operations comprising generating, with the generative neural network, code to remediate the security vulnerability and deploying the code to the cloud computing server system.
